(19) United States
(12) Patent Application Publication
(10) Pub. No.: US 2012/0011201 A1
(43) Pub. Date: Jan. 12, 2012

(54) METHOD AND SYSTEM FOR TRANSMITTING INFORMATION BASED ON SOCIAL NETWORK

(75) Inventors: Yu YIN, Shenzhen City (CN); Gengping CAI, Shenzhen City (CN); Haibin HU, Shenzhen City (CN)

(73) Assignee: TENCENT TECHNOLOGY (SHENZHEN) COMPANY LIMITED, Shenzhen City (CN)

(21) Appl. No.: 13/234,418

(22) Filed: Sep. 16, 2011

Related U.S. Application Data
(63) Continuation of application No. PCT/CN2010/070849, filed on Mar. 3, 2010.

(30) Foreign Application Priority Data
Mar. 18, 2009 (CN) 200910129405.4

(51) Int. Cl. G06F 15/16

(52) U.S. Cl. 709/204

(57) ABSTRACT

A method and system for transmitting information based on social network is provided in the present invention, in order to solve the problem that information transmission within users of a social network may cost high resources. The method includes: calculating information transmission capacity of an obtained user identity according to user information corresponding to the obtained user identity; storing user identities of which transmission capacities are greater than a predetermined threshold into an initial seed user queue; and transmitting information to be sent to a client of which the user identity is stored in the initial seed user queue. Since information to be sent is targeted transmitted to users in a social network having relative high transmission capacities, the cost of information transmission within the users will be reduced.

### FIELD OF THE INVENTION

The present invention relates to computer technology, and more particularly relates to a method and system for transmitting information based on social network.

### BACKGROUND OF THE INVENTION

In the existing Internet, a social network formed by online netizens not only includes a relation between individual users, but also includes one to many relation and many to many relation. The social network includes online users and their relation networks. In the social network, there are massive users and massive relation data. Therefore, how to perform a low-cost and effective transmission of information within the massive users of the social network, e.g., propagandize and promote public benefit activities within netizens, becomes a problem to be solved. In a conventional technology, information concerning propagation and promotion of public benefit activities is randomly sent within netizens. It is apparent that to propagandize and promote information to random users in the social network has a poor pertinence, and may cost high resources for achieving a good effect. For example, when information is to be sent to 1,000 users based on an instant messaging (IM) platform, the 1,000 users for receiving the information to be sent may be selected from 10,000 users. If a desired result is not achieved, another 1,000 users has to be selected randomly for receiving the information, which may occupy a great deal of resources for the IM platform. The same problem also exists in a Web 2.0-based social network.

### SUMMARY OF THE INVENTION

In the conventional art, information transmission within users of a social network may cost high resources. In order to solve this problem, a method for transmitting information based on social network is provided in an embodiment of the present invention, including:

calculating information transmission capacity of an obtained user identity according to user information corresponding to the obtained user identity;

storing user identities of which transmission capacities are greater than a predetermined threshold into an initial seed user queue; and

transmitting information to be sent to a client of which the user identity is stored in the initial seed user queue.

Further, a system for transmitting information based on social network is provided in an embodiment of the present invention, including:

a calculation module, adapted for calculating information transmission capacity of an obtained user identity according to user information corresponding to the obtained user identity;

a writing module, adapted for storing user identities of which transmission capacities are greater than a predetermined threshold into an initial seed user queue; and

a transmitting module, adapted for transmitting information to be sent to a client of which the user identity is stored in the initial seed user queue.

Further, a system for transmitting information based on social network is provided in an embodiment of the present invention, including:

a server, adapted for calculating information transmission capacity of an obtained user identity according to user information corresponding to the obtained user identity, storing user identities of which transmission capacities are greater than a predetermined threshold into an initial seed user queue, expanding the initial seed user queue to get an expanded user queue including a predetermined number of user identities according to the user relation information corresponding to the user identities in the initial seed user queue, and transmitting information to be sent to a client of which the user identity is stored in the initial seed user queue; and

a client with a user identity included in the initial seed user queue, adapted for transmitting information to be sent to other clients of which user identities are included in the expanded user queue.

It can be seen from the above scheme provided in embodiments of the present invention that, since information to be sent is transmitted to target users in a social network having relative high transmission capacities, the cost of information transmission within the users will be reduced.

### BRIEF DESCRIPTION OF DRAWINGS

FIG. 1 is a flow chart illustrating a method provided in the first embodiment of the present invention;

FIG. 2 is a flow chart illustrating a method provided in the first embodiment of the present invention;

FIG. 3 is a block diagram illustrating a system provided in the second embodiment of the present invention;

FIG. 4 is a block diagram illustrating a system provided in the third embodiment of the present invention.

### DETAILED DESCRIPTION OF THE INVENTION

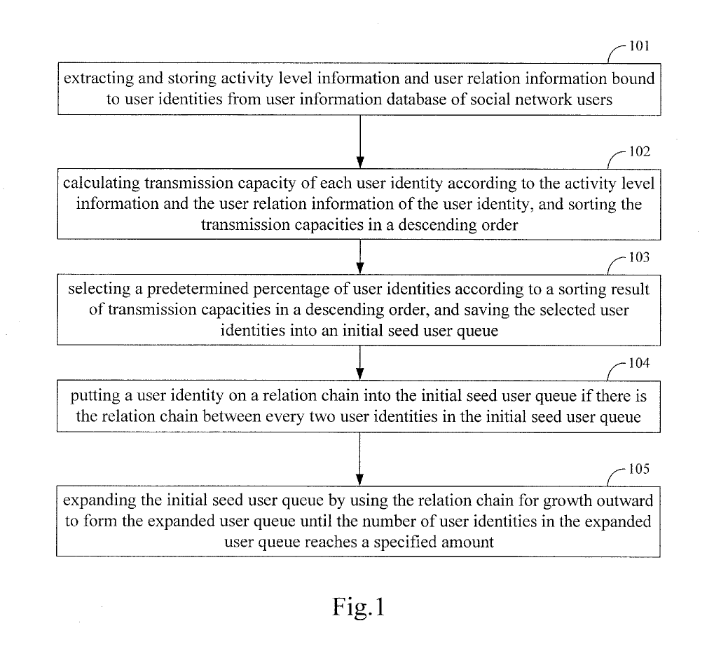

The first embodiment of the present invention provides a method for transmitting information based on social network, of which the process is shown in FIG. 1 which includes the following steps.

Step 101: extracting activity level information and user relation information bound to user identities from a user information database of social network users, and storing them.

Here, the activity level information may include one or more of the following information: online time of a user, a frequency of interacting with friends, a frequency of visiting friends' spaces, a frequency of updating a log space etc., for indicating activity level of the user in the social network. The activity level information can be stored in a way shown in Table 1.

TABLE 1

| Unique | | | | |
|---|---|---|---|---|
| identity | | | | |
| in | | | | |
| a social | | Frequency of | Frequency of | Frequency of |
| network | Online | interacting with | visiting friends' | updating a log |
| system | time | friends | spaces | space |
| 10001 | 3 hours | 30 times per day | 3 times per day | 0.3 times per day |
| 10002 | 2 hours | 20 times per day | 2 times per day | 0.2 times per day |

User relation information is expressed as (ID1, relation type 1), . . . , (IDn, relation type 2), used to represent relation of a user with other users in the social network. For example, relation types are defined as friend, awareness and stranger. For user A, he has a friend B and is aware of C. Also, user A has a visit to a stranger D's blog. Then, the user relation information of user A can be described as (B, Friend), (C, Awareness) and (D, Stranger), which is shown in Table 2.

TABLE 2

| User identity in a | |
|---|---|
| social network system | User relation information |
| 10001 | (ID1, relation type 1), . . . , (IDn, relation type 2) |
| 10002 | (ID1, relation type 2), . . . , (IDn, relation type 1) |

Step 102: calculating transmission capacity of each user identity according to the activity level information and the user relation information of the user identity, and sorting the transmission capacities in a descending order.

For example, an activity level component fₙxₙ corresponding to activity level information xₙ is obtained according to the activity level information xₙ corresponding to user identity 10001 and a coefficient fₙ of the activity level information xₙ, a quantified value A (user ID) of the activity level information corresponding to the user identity is obtained via summing up all activity level components of the user identity, a quantified value R (user ID) of user relation information of the user identity is obtained according to all the user relation information r₁, r₂, . . . , rⱼ corresponding to the user identity, and the transmission capacity T (user ID) of the user identity is obtained via evaluating a weighted sum of the quantified value A (user ID) of the activity level information corresponding to the user identity and the quantified value R (user ID) of the user relation information corresponding to the user identity.

The activity level information corresponding to the user identity is calculated as follows:

$$A ( user ID ) = {\sum }_{n = 1}^{N} {f}_{n} {x}_{n} ,$$

wherein A (user ID) represents a quantified value of activity level information corresponding to a user identity.

Here, N represents the total number of activity level information corresponding to a user identity, xₙ represents activity level information corresponding to a user identity, fₙ represents a coefficient of activity level information corresponding to a user identity wherein

$${\sum }_{n = 1}^{N} {f}_{n} = 1.$$

The user relation information corresponding to the user identity is calculated as follows:

$$R ( user ID ) = {\sum }_{j = 1}^{M} {r}_{j} ,$$

wherein M represents the total number of relation types included in user relation information of a user identity, R (user ID) represents a quantified value of user relation information corresponding to a user identity, rⱼ represents a quantified value of a relation type included in user relation information corresponding to a user identity.

The transmission capacity corresponding to the user identity is calculated via evaluating a weighted sum of A (user ID) and R (user ID) as follows: T (user ID)=A (User ID)*f+R (User ID)*(1−f), wherein T (user ID) represents a transmission capacity corresponding to a user identity, and f is a weight factor.

Step 103: selecting a predetermined percentage of user identities according to a sorting result of transmission capacities in a descending order, and saving the selected user identities into an initial seed user queue.

Of course, selecting a predetermined proportion of user identities according to corresponding transmission capacities ranked in a descending order is, in fact, to choose user identities having transmission capacities greater than a predetermined threshold, and a threshold value can be set appropriately to fit the proportion of user identities being selected to the predetermined proportion. For example, there are 10,000 user identities ranked according to their transmission capacities in a descending order, and a predetermined proportion of the user identities, e.g., 10% are chosen to be added into the initial seed user queue. The top 1,000 user identities are selected according to a predetermined threshold, wherein the predetermined threshold should be less than the transmission capacity corresponding to the 1,000th user identity while greater than the transmission capacity corresponding to the 1,001th user identity. In an instance, the initial seed user queue can have two user identities, such as 10001 and 10002, and the user relation information corresponding to 10001 may include (10002, relation type 1) or not include 10002. Likewise, the user relation information corresponding to 10002 may include (10001, relation type 1) or not include 10001.

Step 104: as to every two user identities in the initial seed user queue, if there is a relation chain between them, a user identity on the relation chain is also put into the initial seed user queue.

For example, user relation information corresponding to user identity 10001 in the initial seed user queue includes (10003, relation type 1), and user relation information corresponding to user identity 10002 includes (10003, relation type 2). Then, there is a relation chain between user identity 10001 and user identity 10002, i.e., 10001-10003-10002, and user identity 10003 on the relation chain previously not included in the initial seed user queue can be added into the initial seed user queue. That is, user identities 10001 and 10002 are two user identities having a transmission capacity greater than a predetermined threshold, and a relation chain created by their respective user relation information includes at least one other user identity, e.g., 10003, wherein user identity 10003 does not belong to the selected user identities having a transmission capacity greater than a predetermined threshold. Then, user identity 10003 will be saved to the initial seed user queue. Similarly, when user relation information corresponding to user identity 10001 in the initial seed user queue includes (10003, relation type 1), user relation information corresponding to user identity 10003 not belonging to the initial seed user queue includes (10004, relation type 1), and user relation information corresponding to user identity 10002 includes (10004, relation type 2), user identities 10001 and 10002 have a relation chain 10001-10003-10004-10002 between them. Thereafter, user identities 10003 and 10004 on the relation chain not previously included in the initial seed user queue are added to the initial seed user queue. After user identity 10003 is added into the initial seed user queue, subsequent transmission of information to be sent within an expanded user queue derived from the initial seed user queue is more efficient.

Step 105: expanding the initial seed user queue by using the relation chain for growth outward to form the expanded user queue until the number of user identities in the expanded user queue reaches a specified amount.

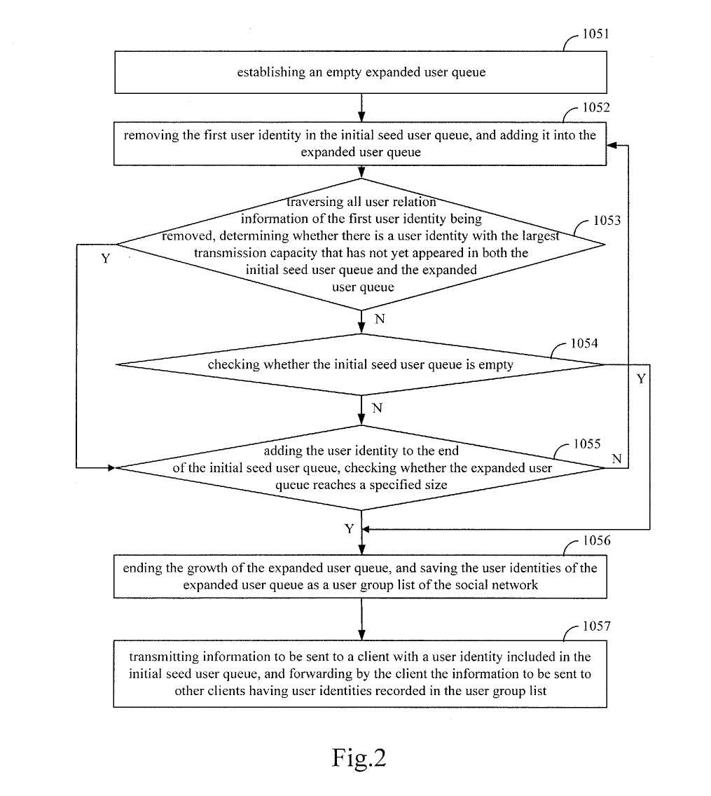

As shown in FIG. 2, a specific implementation of step 105 can include the following steps.

Step 1051: establishing an empty expanded user queue.

Step 1052: removing the first user identity in the initial seed user queue, and adding it into the expanded user queue.

Step 1053: traversing all user relation information of the first user identity being removed, determining whether there is a user identity with the largest transmission capacity that has not yet appeared in both the initial seed user queue and the expanded user queue, and if yes, proceeding to step 1055; otherwise, proceeding to step 1054.

Step 1054: checking whether the initial seed user queue is empty, and if yes, proceeding to step 1056 for ending the growth; otherwise, performing step 1055.

Step 1055: adding the user identity to the end of the initial seed user queue, checking whether the expanded user queue reaches a specified size, and if yes, proceeding to step 1056 for ending the growth; otherwise, turning to step 1052.

Step 1056: ending the growth of the expanded user queue, and saving the user identities of the expanded user queue as a user group list of the social network.

Step 1057: transmitting information to be sent to a client with a user identity included in the initial seed user queue, and forwarding by the client the information to be sent to other clients having user identities recorded in the user group list. As an example, the client can be a software client, web page or wireless mobile and so on.

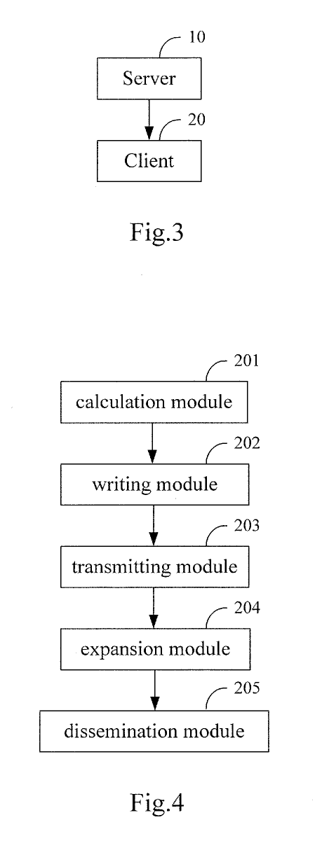

The second embodiment of the present invention provides a system for transmitting information based on social network, which has a structure shown in FIG. 3 including: a server 10 and a client 20.

Server 10 is adapted for storing activity level information and user relation information bound to user identities extracted by server 10 from a user information database of social network users.

Here, the activity level information may include: online time of a user, a frequency of interacting with friends, a frequency of visiting friends' spaces, a frequency of updating a log space etc., for indicating activity level of the user in the social network. The activity level information can be stored in a way shown in Table 1.

TABLE 1

| Unique | | | | |
|---|---|---|---|---|
| identity | | | | |
| in | | | | |
| a social | | Frequency of | Frequency of | Frequency of |
| network | Online | interacting with | visiting friends' | updating a log |
| system | time | friends | spaces | space |
| 10001 | 3 hours | 30 times per day | 3 times per day | 0.3 times per day |
| 10002 | 2 hours | 20 times per day | 2 times per day | 0.2 times per day |

User relation information is expressed as (ID1, relation type 1), . . . , (IDn, relation type 2), used to represent relation of a user with other users in the social network. For example, relation types are defined as friend, awareness and stranger. For user A, he has a friend B and is aware of C. Also, user A has a visit to a stranger D's blog. Then, the user relation information of user A can be described as (B, Friend), (C, Awareness) and (D, Stranger), which is shown in Table 2.

TABLE 2

| User identity in a | |
|---|---|
| social network system | User relation information |
| 10001 | (ID1, relation type 1), . . . , (IDn, relation type 2) |
| 10002 | (ID1, relation type 2), . . . , (IDn, relation type 1) |

The activity level information and the user relation information can be stored on server 10 in a form as shown in Table 1 and Table 2, respectively. Also, they can be stored on other accessible storage spaces of server 10 in other forms.

Server 10 is adapted for calculating transmission capacity of each user identity according to the activity level information and the user relation information of the user identity, and sorting the transmission capacities in a descending order.

For example, an activity level component fₙxₙ corresponding to activity level information xₙ is obtained according to the activity level information xₙ corresponding to user identity 10001 and a coefficient fₙ of the activity level information xₙ, a quantified value A (user ID) of the activity level information corresponding to the user identity is obtained via summing up all activity level components of the user identity, a quantified value R (user ID) of user relation information of the user identity is obtained according to all the user relation information r₁, r₂, . . . , rⱼ corresponding to the user identity, and the transmission capacity T (user ID) of the user identity is obtained via evaluating a weighted sum of the quantified value A (user ID) of the activity level information corresponding to the user identity and the quantified value R (user ID) of the user relation information corresponding to the user identity.

The activity level information corresponding to the user identity is calculated as follows:

$$A ( user ID ) = {\sum }_{n = 1}^{N} {f}_{n} {x}_{n} ,$$

wherein A (user ID) represents a quantified value of activity level information corresponding to a user identity.

Here, N represents the total number of activity level information corresponding to a user identity, xₙ represents activity level information corresponding to a user identity, fₙ represents a coefficient of activity level information corresponding to a user identity wherein

$${\sum }_{n = 1}^{N} {f}_{n} = 1.$$

The user relation information corresponding to the user identity is calculated as follows:

$$R ( user ID ) = {\sum }_{j = 1}^{M} {r}_{j} ,$$

wherein M represents the total number of relation types included in user relation information of a user identity, R (user ID) represents a quantified value of user relation information corresponding to a user identity, rⱼ represents a quantified value of a relation type included in user relation information corresponding to a user identity.

The transmission capacity corresponding to the user identity is calculated via evaluating a weighted sum of A (user ID) and R (user ID) as follows: T (user ID)=A (User ID)*f+R (User ID)*(1-f), wherein T (user ID) represents a transmission capacity corresponding to a user identity, and f is a weight factor.

Server 10 is adapted for selecting a predetermined percentage of user identities according to a sorting result of transmission capacities in a descending order, and saving the selected user identities into an initial seed user queue.

Of course, selecting a predetermined proportion of user identities according to corresponding transmission capacities ranked in a descending order is, in fact, to choose user identities having transmission capacities greater than a predetermined threshold, and a threshold value can be set appropriately to fit the proportion of user identities being selected to the predetermined proportion. For example, there are 10,000 user identities ranked according to their transmission capacities in a descending order, and a predetermined proportion of the user identities, e.g., 10% are chosen to be added into the initial seed user queue. The top 1,000 user identities are selected according to a predetermined threshold, wherein the predetermined threshold should be less than the transmission capacity corresponding to the 1,000th user identity while greater than the transmission capacity corresponding to the 1,001th user identity.

Server 10 is adapted for putting a user identity on a relation chain into the initial seed user queue if there is the relation chain between every two user identities in the initial seed user queue.

For example, user relation information corresponding to user identity 10001 in the initial seed user queue includes (10003, relation type 1), and user relation information corresponding to user identity 10002 includes (10003, relation type 2). Then, there is a relation chain between user identity 10001 and user identity 10002, i.e., 10001-10003-10002, and user identity 10003 on the relation chain previously not included in the initial seed user queue can be added into the initial seed user queue. Similarly, when user relation information corresponding to user identity 10001 in the initial seed user queue includes (10003, relation type 1), user relation information corresponding to user identity 10003 not belonging to the initial seed user queue includes (10004, relation type 1), and user relation information corresponding to user identity 10002 includes (10004, relation type 2), user identities 10001 and 10002 have a relation chain 10001-10003-10004-10002 between them. Thereafter, user identities 10003 and 10004 on the relation chain not previously included in the initial seed user queue are added to the initial seed user queue.

Server 10 is adapted for expanding the initial seed user queue by using the relation chain for growth outward to form the expanded user queue until the number of user identities in the expanded user queue reaches a specified scale.

Server 10 is adapted for establishing an empty expanded user queue. Also, server 10 is adapted for removing user identities from an initial seed user queue according to transmission capacities of user identities ranked in a descending order. For example, server 10 firstly removes the first user identity having the largest transmission capacity, traverses all user relation information of the first user identity being removed, selects from all the user relation information a user identity with the largest transmission capacity that has not yet appeared in the initial seed user queue and adds it into the initial seed user queue, and adds the first user identity into the expanded user queue. Then, server 10 removes the second user identity having the second largest transmission capacity out of the initial seed user queue, traverses all user relation information of the second user identity being removed, selects from all the user relation information a user identity with the largest transmission capacity that has not yet appeared in both the initial seed user queue and the expanded user queue. Server 10 continuously removes user identities from the initial seed user queue, selects from all the user relation information of the removed user identities a new user identity to be added into the initial seed user queue, and adds the removed user identities into the expanded user queue until the number of user identities in the expanded user queue reaches a predetermined amount.

For example, user identities are ranked in a descending order as 10001, 10002 and 10003 according to transmission capacities of the user identities in an initial seed user queue. First, server 10 removes 10001 from the initial seed user queue and adds it into an expanded user queue. At the same time, server 10 goes through all user relation information corresponding to 10001 and chooses user identity 10011, and adds 10011 to the end of the initial seed user queue. Here, candidate user identities include 20001, 10011 and 10003, and the sequence of the user identities is 10003, 10011 and 20001 ranked according to transmission capacities in a descending order. Then, the initial seed user queue is 10002, 10003 and 10011, and the expanded user queue is 10001.

Also, server 10 removes 10002 from the initial seed user queue and adds it into the expanded user queue. At the same time, server 10 goes through all user relation information corresponding to 10002 and chooses user identity 10012, and adds 10012 to the end of the initial seed user queue. Here, candidate user identities include 20002, 10012 and 10003, and the sequence of the user identities is 10003, 10012 and 20002 ranked according to transmission capacities in a descending order. Then, the initial seed user queue is 10003, 10011 and 10012, and the expanded user queue is 10001 and 10002.

Further, server 10 removes 10003 from the initial seed user queue and adds it into the expanded user queue. At the same time, server 10 goes through all user relation information corresponding to 10003 and chooses user identity 10013, and adds 10013 to the end of the initial seed user queue. Here, candidate user identities include 20003, 10013, 10001 and 10002, and the sequence of the user identities is 10001, 10002, 10013 and 20003 ranked according to transmission capacities in a descending order. Then, the initial seed user queue is 10011, 10012 and 10013, and the expanded user queue is 10001, 10002 and 10003.

Further, server 10 removes 10011 from the initial seed user queue and adds it into the expanded user queue. At the same time, server 10 goes through all user relation information corresponding to 10011 and chooses no user identity that can be added into the end of the initial seed user queue. Here, candidate user identities include 10001 and 10012, while 10001 is in the expanded user queue and 10012 is in the initial seed user queue. Then, the initial seed user queue is 10012 and 10013, and the expanded user queue is 10001, 10002, 10003 and 10011.

Further, server 10 removes 10012 from the initial seed user queue and adds it into the expanded user queue. At the same time, server 10 goes through all user relation information corresponding to 10012 and chooses user identity 10112, adds 10112 to the end of the initial seed user queue. Here, candidate user identities include 20002, 10002 and 10112, and the sequence of the user identities is 10002, 10112 and 20002 ranked according to transmission capacities in a descending order. Then, the initial seed user queue is 10013 and 10112, and the expanded user queue is 10001, 10002, 10003, 10011 and 10012. If a predetermined number of user identities in the expanded user queue is 5, server 10 ends the growth at this time.

If the predetermined number of user identities of the expanded user queue is 8, server 10 continues to remove 10013 and 10112 from the initial seed user queue and add them into the expanded user queue, respectively. At the same time, server 10 goes through all user relation information corresponding to 10013 and 10112, but finds no user identity that can be added to the end of the initial seed user queue. Then, the initial seed user queue is empty, and the expanded user queue is 10001, 10002, 10003, 10011, 10012, 10013 and 10112. After that, server 10 ends the growth.

The above is merely a preferred instance. Broadly speaking, server 10 can form an expanded user queue via expanding the initial seed user queue by using a relation chain for growth outward, until the number of user identities of the expanded user queue meets a specified scale.

Server 10 may perform the following steps when forming the expanded user queue according to the initial seed user queue by using a relation chain for growth outward.

Step 2051: establishing an empty expanded user queue.

Step 2052: removing a first user identity from the initial seed user queue, and adding it into the expanded user queue.

Step 2053: traversing all user relation information of the first user identity being removed, determining whether there is a user identity with the largest transmission capacity that has not yet appeared in both the initial seed user queue and the expanded user queue, and if yes, proceeding to step 2055; otherwise, proceeding to step 2054.

Step 2054: checking whether the initial seed user queue is empty, and if yes, proceeding to step 2056 for ending the growth; otherwise, performing step 2055.

Step 2055: adding the user identity to the end of the initial seed user queue, checking whether the expanded user queue reaches a specified size, and if yes, proceeding to step 2056 for ending the growth; otherwise, turning to step 2052.

Step 2056: ending the growth of the expanded user queue, and saving the user identities of the expanded user queue as a user group list of the social network.

Then, server 10 transmits the information to be sent to a client having the user identity recorded in the initial seed user queue.

Client 20, which has the user identity recorded in the initial seed user queue, receives the information to be sent, and transmits the information to clients having user identities included in the user group list.

The third embodiment of the present invention provides a system for transmitting information based on social network having a structure as shown in FIG. 4, which includes:

a calculation module 201, adapted for calculating information transmission capacity of an obtained user identity according to user information corresponding to the obtained user identity;

a writing module 202, adapted for storing user identities of which transmission capacities are greater than a predetermined threshold into an initial seed user queue; and

a transmitting module 203, adapted for transmitting information to be sent to a client of which the user identity is stored in the initial seed user queue.

Specifically, the calculation module 201 is adapted for: calculating information transmission capacity of an obtained user identity according to activity level information and user relation information corresponding to the obtained user identity.

The system further includes:

an expansion module 204, adapted for expanding the initial seed user queue to get an expanded user queue including a predetermined number of user identities according to the user relation information corresponding to the user identities in the initial seed user queue;

a dissemination module 205, adapted for transmitting the information to be sent to a client with a user identity included in the expanded user queue via the client with the user identity included in the initial seed user queue.

Further, the calculation module 201 is adapted for: calculating information transmission capacity of an obtained user identity according to online time of a user, and/or a frequency of interacting with friends, and/or a frequency of visiting friends' spaces, and/or a frequency of updating a log space, and user relation information corresponding to the obtained user identity.

Further, the calculation module 201 is adapted for calculating the activity level information corresponding to the user identity as follows:

$$A ( user ID ) = {\sum }_{n = 1}^{N} {f}_{n} {x}_{n} ,$$

wherein A (user ID) represents a quantified value of activity level information corresponding to a user identity.

Here, N represents the total number of activity level information corresponding to a user identity, xₙ represents activity level information corresponding to a user identity, fₙ represents a coefficient of activity level information corresponding to a user identity wherein

$${\sum }_{n = 1}^{N} {f}_{n} = 1.$$

Also, the user relation information corresponding to the user identity is calculated by the calculation module 201 as follows:

$$R ( user ID ) = {\sum }_{j = 1}^{M} {r}_{j} ,$$

wherein M represents the total number of relation types included in user relation information of a user identity, R (user ID) represents a quantified value of user relation information corresponding to a user identity, rⱼ represents a quantified value of a relation type included in user relation information corresponding to a user identity.

Also, the transmission capacity corresponding to the user identity is calculated by the calculation module 201 via evaluating a weighted sum of A (user ID) and R (user ID) as follows: T (user ID)=A (User ID)*f+R (User ID)*(1−f), wherein T (user ID) represents a transmission capacity corresponding to a user identity, and f is a weight factor.

Further, the writing module 202 is further adapted for: adding another user identity into the initial seed user queue when it is determined that a relation chain formed by user relation information of two user identities having a transmission capacity larger than a predetermined threshold includes the another user identity not previously included in the initial seed user queue, wherein the another user identity does not belong to the selected user identities having a transmission capacity larger than a predetermined threshold.

The calculation module is adapted for: obtaining an activity level component corresponding to activity level information of a user identity according to both the activity level information and a coefficient of the activity level information;

calculating the sum of all activity level components corresponding to a user identity to get a quantified value of the activity level information corresponding to the user identity;

obtaining a quantified value of user relation information of the user identity according to all user relation information corresponding to the user identity; and

calculating a weighted sum of the quantified value of the activity level information corresponding to the user identity and the quantified value of the user relation information corresponding to the user identity to get the transmission capacity of the user identity.

The writing module is further adapted for: storing user identities of which transmission capacities are smaller than a predetermined threshold into the initial seed user queue.

Further, the expansion module 204 is further adapted for: removing user identities from an initial seed user queue in a descending order according to transmission capacities of the user identities; traversing all user relation information corresponding to the removed user identities; selecting a user identity having the largest transmission capacity and has not yet included in both the initial seed user queue and the expanded user queue, and adding the user identity into the initial seed user queue; and adding the removed user identities into the expanded user queue until the predetermined number of the user identities of the expanded user queue is arrived.

The expansion module is further adapted for: removing user identities from an initial seed user queue, selecting a user identity according to all user relation information corresponding to the removed user identities and adding the user identity into the initial seed user queue, and adding the removed user identities into the expanded user queue.

It is clear that those skilled in the art can make various modifications and variations on the present invention without departing from the spirit and scope of the present invention. Thus, if the modifications and variations of the present invention are within the scope of claims of the present invention and its equivalent technology, the present invention is also intended to include these modifications and variations.

1. A method for transmitting information based on social network, comprising:
calculating information transmission capacity of an obtained user identity according to user information corresponding to the obtained user identity;
storing user identities of which transmission capacities are greater than a predetermined threshold into an initial seed user queue; and
transmitting information to be sent to a client of which the user identity is stored in the initial seed user queue.

2. The method of claim 1, wherein the user information comprises: activity level information and user relation information.

3. The method of claim 2, further comprising:
after storing user identities of which transmission capacities are greater than a predetermined threshold into an initial seed user queue, expanding the initial seed user queue to get an expanded user queue including a predetermined number of user identities according to the user relation information corresponding to the user identities in the initial seed user queue; and
after transmitting information to be sent to a client of which the user identity is stored in the initial seed user queue, transmitting the information to be sent to a client with a user identity included in the expanded user queue via the client with the user identity included in the initial seed user queue.

4. The method of claim 2, wherein the activity level information of a user comprises: online time of the user, and/or a frequency of interacting with friends, and/or a frequency of visiting friends' spaces, and/or a frequency of updating a log space.

5. The method of claim 4, wherein calculating information transmission capacity of an obtained user identity according to activity level information and user relation information corresponding to the obtained user identity comprises:
obtaining an activity level component corresponding to activity level information of a user identity according to both the activity level information and a coefficient of the activity level information;
calculating the sum of all activity level components corresponding to a user identity to get a quantified value of the activity level information corresponding to the user identity;
obtaining a quantified value of user relation information of the user identity according to all user relation information corresponding to the user identity; and
calculating a weighted sum of the quantified value of the activity level information corresponding to the user identity and the quantified value of the user relation information corresponding to the user identity to get the transmission capacity of the user identity.

6. The method of claim 3, further comprising:
after storing user identities of which transmission capacities are greater than a predetermined threshold into an initial seed user queue and before expanding the initial seed user queue according to the user relation information corresponding to the user identities in the initial seed user queue, if a relation chain formed by user relation information of two user identities of which transmission capacities are greater than a predetermined threshold has at least one user identity not included in the initial seed user queue, storing the user identity into the initial seed user queue.

7. The method of claim 3, wherein expanding the initial seed user queue to get an expanded user queue including a predetermined number of user identities according to the user relation information corresponding to the user identities in the initial seed user queue comprises:
removing user identities from an initial seed user queue in a descending order according to transmission capacities of the user identities;
traversing all user relation information corresponding to the removed user identities;
selecting a user identity having the largest transmission capacity and has not yet included in both the initial seed user queue and the expanded user queue, and adding the user identity into the initial seed user queue; and
adding the removed user identities into the expanded user queue until the predetermined number of the user identities of the expanded user queue is arrived.

8. A system for transmitting information based on social network, comprising:
a calculation module, adapted for calculating information transmission capacity of an obtained user identity according to user information corresponding to the obtained user identity;
a writing module, adapted for storing user identities of which transmission capacities are greater than a predetermined threshold into an initial seed user queue; and
a transmitting module, adapted for transmitting information to be sent to a client of which the user identity is stored in the initial seed user queue.

9. The system of claim 8, wherein the calculation module is adapted for: calculating information transmission capacity of an obtained user identity according to activity level information and user relation information corresponding to the obtained user identity.

10. The system of claim 8, further comprising:
an expansion module, adapted for expanding the initial seed user queue to get an expanded user queue including a predetermined number of user identities according to the user relation information corresponding to the user identities in the initial seed user queue;
a dissemination module, adapted for transmitting the information to be sent to a client with a user identity included in the expanded user queue via the client with the user identity included in the initial seed user queue.

11. The system of claim 8, wherein the calculation module is adapted for: calculating information transmission capacity of an obtained user identity according to online time of a user, and/or a frequency of interacting with friends, and/or a frequency of visiting friends' spaces, and/or a frequency of updating a log space, and user relation information corresponding to the obtained user identity.

12. The system of claim 9, wherein the calculation module is adapted for: obtaining an activity level component corresponding to activity level information of a user identity according to both the activity level information and a coefficient of the activity level information;
calculating the sum of all activity level components corresponding to a user identity to get a quantified value of the activity level information corresponding to the user identity;
obtaining a quantified value of user relation information of the user identity according to all user relation information corresponding to the user identity; and
calculating a weighted sum of the quantified value of the activity level information corresponding to the user identity and the quantified value of the user relation information corresponding to the user identity to get the transmission capacity of the user identity.

13. The system of claim 8, wherein the writing module is further adapted for: adding another user identity into the initial seed user queue when it is determined that a relation chain formed by user relation information of two user identities having a transmission capacity larger than a predetermined threshold includes the another user identity not previously included in the initial seed user queue.

14. The system of claim 10, wherein the expansion module is further adapted for: removing user identities from an initial seed user queue, selecting a user identity according to all user relation information corresponding to the removed user identities and adding the user identity into the initial seed user queue, and adding the removed user identities into the expanded user queue.

15. A system for transmitting information based on social network, comprising:
a server, adapted for calculating information transmission capacity of an obtained user identity according to user information corresponding to the obtained user identity, storing user identities of which transmission capacities are greater than a predetermined threshold into an initial seed user queue, expanding the initial seed user queue to get an expanded user queue including a predetermined number of user identities according to the user relation information corresponding to the user identities in the initial seed user queue, and transmitting information to be sent to a client of which the user identity is stored in the initial seed user queue; and
a client with a user identity included in the initial seed user queue, adapted for transmitting information to be sent to other clients of which user identities are included in the expanded user queue.
